(19) United States
(12) Patent Application Publication
(10) Pub. No.: US 2006/0146477 A1
(43) Pub. Date: Jul. 6, 2006

(54) Capacitor having multiple dielectric layer and method of forming the same

(75) Inventors: Kyong-Min Kim, Ansan-si (KR); Soon-Haeng Lee, Yongin-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/320,328

(22) Filed: Dec. 28, 2005

(30) Foreign Application Priority Data
Jan. 3, 2005 (KR) 2005-00274

(51) Int. Cl. H01G 4/06

(52) U.S. Cl. 361/311

(57) ABSTRACT

A capacitor and a method of forming the same are provided. The capacitor includes a lower electrode, a first hafnium oxide layer formed on the lower electrode, a tantalum oxide layer formed on the hafnium oxide layer, a second hafnium oxide layer formed on the tantalum oxide layer and an upper electrode formed on the second hafnium oxide layer.

### CROSS-REFERENCE TO RELATED APPLICATIONS

This U.S. non-provisional patent application claims priority under 35 U.S.C. § 119 of Korean Patent Application 2005-00274 filed on Jan. 3, 2005, the entire contents of which are hereby incorporated by reference in their entirety.

### BACKGROUND OF THE INVENTION

The present invention relates to a capacitor employed in semiconductor devices and methods of forming the same, more particularly, to a capacitor having a multiple dielectric layer and to methods of forming the same.

In general, the dielectric characteristics of a dielectric layer used in a capacitor are estimated by a thickness known as Equivalent oxide thickness (Toxeq) and leakage current density. As the equivalent oxide thickness of the dielectric layer decreases, the capacitance of a unit area of the capacitor increases. In addition, as the leakage current density decreases, the ability of the semiconductor device to maintain data is improved and the power consumed by the semiconductor device also decreases.

Moreover, in the semiconductor industry, a dielectric layer with a high dielectric constant is currently being sought to increase the capacitance of a capacitor. For example, recently, a hafnium oxide layer has been suggested for use as a dielectric layer for a capacitor. However, while hafnium oxide layer may have a high dielectric constant, it also has a high leakage current density. In an attempt to overcome the above-mentioned difficulty of the hafnium oxide layer, certain conventional capacitors employ an aluminum oxide layer having a relatively low leakage current density and a hafnium oxide layer having a high dielectric constant stacked on a lower electrode to form a capacitor dielectric layer.

FIG. 1 is a cross-sectional view illustrating a conventional capacitor.

Referring to FIG. 1, a lower electrode 12 is formed on a substrate 10. In addition, a capacitor dielectric layer is formed of an aluminum oxide layer 14 and a hafnium oxide layer 16 stacked on the lower electrode 12. An upper electrode 18 is then formed on the capacitor dielectric layer. As mentioned above, an aluminum oxide layer has a lower dielectric constant in comparison to a hafnium oxide layer. However, aluminum oxide also has a relatively low leakage current density. Thus, in the above-mentioned conventional capacitors, an aluminum oxide layer was formed in conjunction with hafnium oxide layer in an attempt to reduce the leakage current density of the capacitor dielectric layer.

However, as semiconductor devices become more highly integrated, the area of a capacitor of these devices also decreases. Therefore, clearly it is difficult to secure a sufficient capacitance for a capacitor having an aluminum oxide layer since these aluminum oxide layers have a low dielectric constant.

### SUMMARY OF THE INVENTION

In one preferred embodiment of the present invention a capacitor is provided. The capacitor comprises a lower electrode a first hafnium oxide layer formed on the lower electrode, a tantalum oxide layer formed on the first hafnium oxide layer, a second hafnium oxide layer formed on the tantalum oxide layer, and an upper electrode formed on the second hafnium oxide layer.

In another preferred embodiment of the present invention, a method for forming a capacitor is provided. The method for forming a capacitor comprises forming a lower electrode layer on a substrate, forming a first hafnium oxide layer on the lower electrode layer, forming a tantalum oxide layer on the first hafnium oxide layer, forming a second hafnium oxide layer on the tantalum oxide layer and then forming an upper electrode layer on the second hafnium oxide layer.

### BRIEF DESCRIPTION OF THE DRAWINGS

FIG. 1 is a cross-sectional view of a conventional capacitor;

FIG. 2 is a cross-sectional view of a capacitor in accordance with a preferred embodiment of the present invention;

FIG. 3 is a flow chart for describing a method for forming a capacitor in accordance with a preferred embodiment of the present invention;

FIG. 4 is a flow chart for describing a method for forming a capacitor in accordance with a preferred embodiment of the present invention; and

FIG. 5 is a flow chart for describing a method for forming a capacitor in accordance with a preferred embodiment of the present invention.

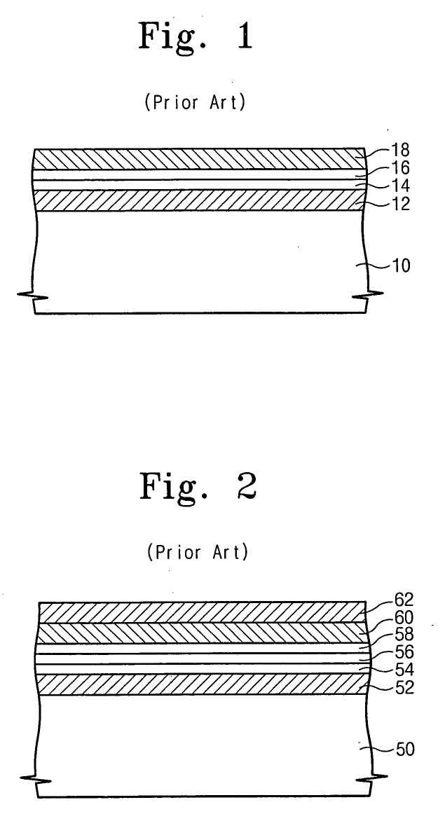

### DETAILED DESCRIPTION OF PREFERRED EMBODIMENTS

The present invention will now be described more fully hereinafter with reference to the accompanying drawings, in which preferred embodiments of the invention are shown. This invention may, however, be embodied in different forms and should not be constructed as limited to the embodiments set forth herein.

It will also be understood that when a layer is referred to as being “on” another layer or substrate, it can be directly on the other layer or substrate or intervening layers may also be present. In the drawings, the thickness of layers and regions are exaggerated for clarity.

FIG. 2 is a cross-sectional view of a capacitor in accordance with a preferred embodiment of the present invention.

Referring to FIG. 2, the capacitor has a lower electrode 52 formed on a substrate 50, a multiple dielectric layer formed on the lower electrode, and comprised of a first hafnium oxide layer 54, a tantalum oxide layer 56 and a second hafnium oxide layer 58 stacked on the lower electrode 52. In addition, an upper electrode 60 is formed on the multiple dielectric layer. Further, a protective metal layer 62 is formed on the upper electrode 60. The lower electrode 52 and the upper electrode 60 are formed of a titanium nitride layer using a metal-organic-chemical-vapor-deposition (MOCVD) method.

As discussed above, the hafnium oxide layer has a high leakage current density. Moreover, when the crystallization temperature becomes high, the leakage current density of the hafnium oxide is decreased. Thus, a tantalum oxide layer 56 is interposed between the first hafnium oxide layer 54 and the second hafnium oxide layer 58 to form interfaces to the hafnium oxide and to prevent the hafnium oxide layers from being crystallized. As a result of the above, the hafnium oxide layers are crystallized at a higher temperature as compared to when hafnium oxide is formed as a single layer. In addition, the leakage current density of the dielectric layer is also decreased when comprised of the first hafnium oxide layer 54, the tantalum oxide layer 56 and the second hafnium oxide layer. The tantalum oxide layer 56 has a dielectric constant of 20 through 25. Accordingly, the capacitor according to exemplary embodiments of the present invention provides a higher capacitance in comparison with a conventional capacitor which utilizes an aluminum oxide layer.

It is preferable that the first and the second hafnium oxide layers 54 and 58 are formed to be thicker than the tantalum oxide layer for obtaining a lower leakage current density and a higher capacitance for the capacitor. For example, the first hafnium oxide layer 54 and the second hafnium oxide layer 58 are formed to have a thickness of about 10 angstrom (Å) to about 30 angstroms (Å), and the tantalum oxide layer 56 is formed to have a thickness of about 2 angstoms (Å) to about 10 angstroms (Å). Accordingly, the hafnium oxide layers 54, 58 with a high leakage current density are formed to be thicker to lower their leakage current density, and the tantalum oxide layer with a high dielectric constant is formed to be thinner to increase its capacitance.

Protective metal layer 62 is formed of a titanium nitride layer. To prevent the capacitor from being etch-damaged during the step of forming a plate electrode, the protective metal layer 62 is formed of a titanium nitride layer using a physical vapor deposition (PVD) method.

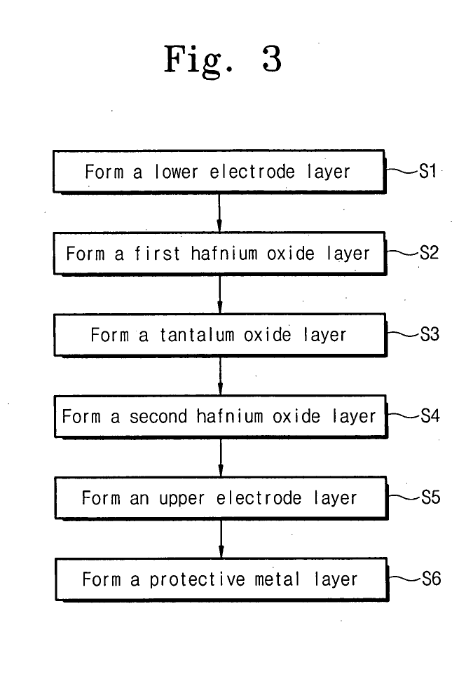

FIG. 3 is a flow chart for describing a method for forming a capacitor in accordance with a preferred embodiment of the present invention.

Referring to FIG. 3, a lower electrode layer is formed on a substrate (step S1). The lower electrode layer is formed of a titanium oxide layer using the MOCVD method. For example, the deposition is performed at a temperature ranging from about 300° C. to about 400° C. using tetrakis dimethylamino titanium (TDMAT)(Ti[N(CH₃)₂]₄) as a titanium precursor and ammonia (NH₃) as a reaction gas. The chamber pressure is maintained at about 0.2 Torr to about 2 Torr. The titanium nitride layer is deposited in several steps to remove impurities in the titanium nitride layer. At this point, after the titanium nitride layer is deposited with a predetermined thickness, the environment of the chamber is changed to a nitrogen and oxygen atmosphere. Plasma is turned on so that the deposited titanium nitride layer is plasma-treated to remove impurities in the titanium nitride layer.

Further, at this point, the high frequency power is maintained at about 50 Watt to about 400 Watt. Moreover, the lower electrode layer is formed to have a thickness of about 200 Å to about 400 Å. In addition, a first hafnium oxide layer is formed on the lower electrode layer (step S2). The first hafnium oxide layer is formed using an atomic layer deposition method. For example, tetrakis ethylmethylamido hafnium (TEMAH) (Hf[N(C₂H₅)CH₃]₄) is provided as a hafnium precursor to form a hafnium precursor layer on the lower electrode layer and purged. Ozone is provided as an oxygen gas to transform the hafnium precursor layer into a hafnium oxide layer and purged. The providing of TEMAH through purging ozone constitutes a deposition cycle. The deposition cycle is repeatedly carried out to form a hafnium oxide layer having a desired thickness. At this point, the hafnium oxide layer is formed at a relatively low temperature of about 250° C. to about 350° C., and a high frequency power is formed at about 200 Watt to about 100 Watt. At this point, the time for providing and purging the precursor and the oxygen gas is about 0.1 second to about 10 seconds. The first hafnium oxide layer is formed to have a thickness of about 10 angstroms (Å) to about 30 angstroms (Å).

Further, a tantalum oxide layer is formed on the first hafnium oxide layer (step S3). The tantalum oxide layer is formed using an atomic layer deposition or a chemical vapor deposition method. For example, after tantalum ethoxide, (Ta(OC₂H₅)₅) is provided as a tantalum precursor, a tantalum precursor layer is formed on a first hafnium oxide layer and purged. Ozone is provided as an oxygen gas to form the tantalum oxide layer by a replacement reaction with the tantalum precursor layer and purged. A cycle comprised of providing the tantalum precursor through purging ozone is repeatedly carried out to form the tantalum oxide layer with a desired thickness. The tantalum precursor is provided for about 0.1 second to about 20 seconds, and purged for about 0.1 second to about 10 seconds using a nitrogen gas as a purging gas. In addition, the oxygen gas is provided for about 0.1 second to about 15 seconds and purged for about 0.1 seconds to about 10 seconds using nitrogen gas. The tantalum oxide layer is deposited at a relatively high temperature ranging from about 300° C. to about 400° C. It is preferable that the tantalum oxide layer is formed to be thinner than the first hafnium oxide layer, such as to a thickness of about 2 angstroms (Å) to about 10 angstroms (Å). The tantalum oxide layer is formed by a chemical vapor deposition method. At this point, the tantalum precursor and the oxygen gas are provided in a chamber to form a tantalum oxide layer.

A second hafnium oxide layer is then formed on the tantalum oxide layer (step S4). The second hafnium oxide layer is formed under the same conditions as the first hafnium oxide layer. For example, the second hafnium oxide layer is formed by an atomic layer deposition under the same conditions as the first hafnium oxide layer. As the tantalum oxide layer is formed between the first and the second hafnium oxide layers, crystallization of the hafnium oxide layer is inhibited by an interfacial action of the hafnium oxide layer and the tantalum oxide layer. When the hafnium oxide layer is crystallized at a high temperature, grains become dense, and the impurities in a hafnium oxide layer are let out, thereby providing the effect of lowering the leakage current density.

In addition, the tantalum oxide layer with the relatively low leakage current density and a high dielectric constant is formed thinly to increase the capacitance and prevent the leakage current density from being increased.

An upper electrode is then formed on the second hafnium oxide layer (step S5). The upper electrode layer is formed under the same conditions as the lower electrode layer. In other words, the upper electrode layer is formed of a titanium nitride layer using the same MOCVD method used in forming the lower electrode layer.

Next, a protective metal layer is formed on the upper electrode layer (step S6). The protective metal layer functions to prevent the capacitor from being etch-damaged during the process for forming a plate electrode. Accordingly, the titanium nitride layer is formed of an etch-resistance material.

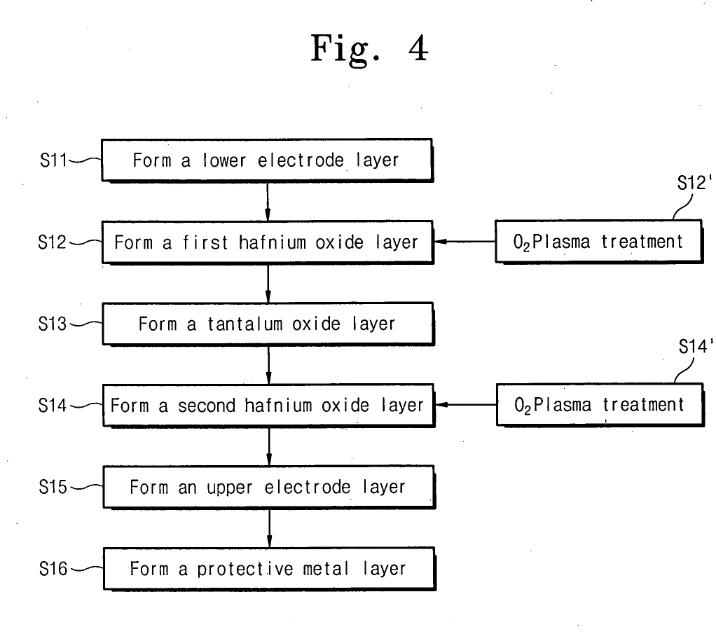

FIG. 4 is a flow chart for describing a method for forming a capacitor in accordance with a preferred embodiment of the present invention.

Referring to the preferred embodiment of FIG. 4, this preferred embodiment is similar to the previous preferred embodiment of FIG. 3, except for the differences set forth below. Like in the preferred embodiment of FIG. 3, after a lower electrode layer is formed on a substrate, a first hafnium oxide layer, a tantalum oxide layer and a second hafnium oxide layer are sequentially formed on a lower electrode (steps S11 through S14). At this point, the first hafnium oxide layer is formed using an atomic layer deposition like in the preferred embodiment of FIG. 3. However, the deposition cycle in the preferred embodiment of FIG. 4 further comprises oxygen plasma treatment after forming a hafnium oxide layer. In other words, after a hafnium precursor layer is reacted with an oxygen gas to form a hafnium oxide layer and purged, an oxygen gas or an ozone gas is provided in amounts of about 20 standard cubic centimeters per minute (sccm) to about 200 standard cubic centimeters per minute (sccm) and transferred into a plasma state. Then, the hafnium oxide layer is plasma-treated. (steps “S12” and “S14”) At this point, the high frequency power is maintained at about 20 Watt to about 100 Watt. The hafnium oxide layer is plasma-treated to let out the impurities in the hafnium oxide layer. For example, carbon, nitrogen and hydrogen atoms remaining in the hafnium oxide layer are combined with a highly reactive oxygen excited by plasma, and are emitted as carbon monoxide, carbon dioxide and an amine group. The step of forming a hafnium oxide layer and the oxygen plasma treatment is repeatedly carried out to form the hafnium oxide layer with a desired thickness.

Subsequently, an upper electrode layer is formed on the second hafnium oxide layer, and a protective metal layer is formed on the upper electrode layer (step S16). It is noted that the upper electrode layer and the protective metal layer in this preferred embodiment are formed under the same conditions used for the formation of these layers in the preferred embodiment of FIG. 3.

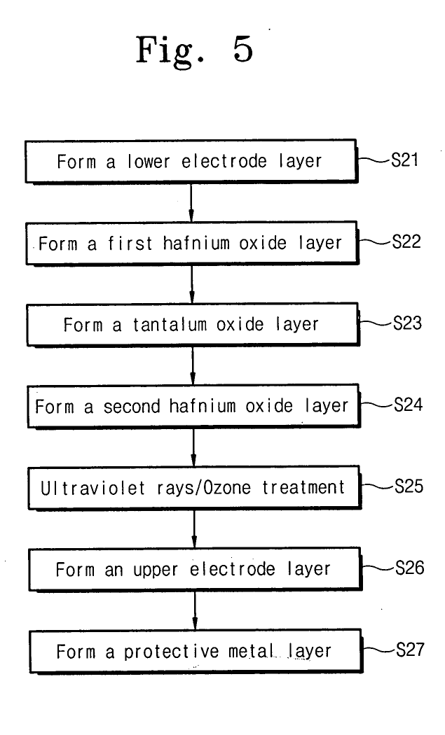

FIG. 5 is a flow chart for describing a method for forming a capacitor in accordance with a preferred embodiment of the present invention.

This preferred embodiment is a method for removing impurities in a dielectric layer and reducing a leakage current density similar to the method set forth in the preferred embodiment of FIG. 4.

Referring to FIG. 5, a lower electrode layer, a first hafnium oxide layer, a tantalum oxide layer and a second hafnium oxide layer are formed under the same conditions as in the preferred embodiments of FIGS. 3 and 4. (steps S21 through S24). The multiple dielectric layer comprises the first hafnium oxide layer, the tantalum oxide layer and the second hafnium oxide layer. Further, the multiple dielectric layer is treated with ultraviolet rays/ozone (UV/O₃) so that impurities in the multiple dielectric layer are removed (step S25). For example, the amount of ozone is maintained at about 100,000 parts per million (ppm) to about 200,000 parts per million (ppm) at a temperature ranging from about 300° C. to about 400° C., and ulraviolet rays are irradiated to transform ozone molecules into a highly reactive oxygen atom or oxygen radical. The impurities in the dielectric layer and oxygen atom or oxygen radical are combined. Then, the impurities are gased out. The ultraviolet rays/ozone treatment is performed for about 30 seconds to about 120 seconds.

Subsequently, an upper electrode layer is formed on the second hafnium oxide layer and a protective metal layer is formed on the upper electrode layer (steps S26 and S27). The upper electrode layer and the protective metal layer in this preferred embodiment are formed under the same conditions as in the preferred embodiments of FIGS. 3 and 4.

Having described the preferred embodiments of the present invention, it is further noted that it is readily apparent to those of reasonable skill in the art that various modifications may be made without departing from the spirit and scope of the invention which is defined by the metes and bounds of the appended claims.

What is claimed is:

1. A capacitor comprising:
a lower electrode;
a first hafnium oxide layer formed on the lower electrode;
a tantalum oxide layer formed on the first hafnium oxide layer;
a second hafnium oxide layer formed on the tantalum oxide layer; and
an upper electrode formed on the second hafnium oxide layer.

2. The capacitor of claim 1, further comprising a protective metal layer formed on the upper electrode.

3. The capacitor of claim 2, wherein the protective metal layer is a titanium nitride layer formed by a physical vapor deposition (PVD) method.

4. The capacitor of claim 1, wherein the lower electrode and the upper electrode are titanium nitride layers formed by a Metal Organic Chemical Vapor Deposition (MOCVD) method.

5. A method for forming a capacitor comprising:
forming a lower electrode layer on a substrate;
forming a first hafnium oxide layer on the lower electrode layer;
forming a tantalum oxide layer on the first hafnium oxide layer;
forming a second hafnium oxide layer on the tantalum oxide layer; and
forming an upper electrode layer on the second hafnium oxide layer.

6. The method of claim 5, wherein an atomic layer deposition and an oxygen plasma treatment are repeatedly carried out to form the first hafnium oxide layer and the second hafnium oxide layer, respectively.

7. The method of claim 6, wherein repeated deposition cycles of the forming of the first hafnium oxide layer and the second hafnium oxide layer comprise:
providing a hafnium precursor;
purging the hafnium precursor;
providing an oxidation gas to form a hafnium oxide layer;
purging an oxidation gas; and
treating the hafnium oxide layer with oxygen plasma.

8. The method of claim 5, further comprising performing an ultraviolet rays/ozone (UV/O₃) treatment to the resultant structure where the second hafnium oxide layer is formed.

9. The method of claim 5, wherein the first hafnium oxide layer and the second hafnium oxide layer are deposited at a temperature ranging from about 250° C. to about 350° C.

10. The method of claim 5, wherein the tantalum oxide layer is deposited at a temperature ranging from about 300° C. to about 400° C.

11. The method of claim 5, wherein the tantalum oxide layer is formed using an atomic layer deposition method.

12. The method of claim 5, wherein the tantalum oxide layer is formed using a chemical vapor deposition method.

13. The method of claim 5, wherein the upper electrode layer and the lower electrode layer are formed of a titanium nitride layer using a Metal Organic Chemical Vapor Deposition (MOCVD) method.

14. The method of claim 13, wherein the step of forming the upper electrode layer and the lower electrode layer comprises:
providing a tetrakis dimethylamino titanium (TDMAT) (Ti[N(CH₃)₂]₄) source and an ammonia (NH₃) gas to deposit a titanium nitride layer; and
plasma treating the titanium nitride layer in a nitrogen and oxygen atmosphere.

15. The method of claim 5, further comprising: forming a protective metal layer on the upper electrode layer.

16. The method of claim 15, wherein the protective metal layer is formed of a titanium nitride layer using a physical vapor deposition (PVD) method.

17. The capacitor of claim 1, wherein the first and the second hafnium oxide layers each have a thickness of about 10 angstroms (Å) to about 30 angstroms (Å).

18. The capacitor of claim 1, wherein the tantalum oxide layer has a thickness of about 2 angstroms (Å) to about 10 angstroms (Å).

19. The method of claim 5, wherein the first and the second hafnium oxide layers are each formed to have a thickness of about 10 angstroms (Å) to about 30 angstroms (Å).

20. The method of claim 5, wherein the tantalum oxide layer is formed to a thickness of about 2 angstroms (Å) to about 10 angstroms (Å).
